(19) United States
(12) Patent Application Publication
(10) Pub. No.: US 2008/0241554 A1
(43) Pub. Date: Oct. 2, 2008

(54) Hard coat film

(75) Inventor: Shukiko Tanaka, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/079,300

(22) Filed: Mar. 25, 2008

(30) Foreign Application Priority Data
Mar. 27, 2007 (JP) 2007-080436

(51) Int. Cl. B32B 9/04

(52) U.S. Cl. 428/451

(57) ABSTRACT

One example of the present invention is a hard coat film in which a hard coat liquid is caked and forms a hard coat layer (D) stacked on at least one side of a triacetylcellulose film (A), the hard coat liquid contains a solvent (E) in which the triacetylcellulose film (A) dissolves or swells and a UV-curable resin ingredient consisting primarily of a reactive polyether modified silicone compound (C) and a polyfunctional monomer (B) having at least two metaacryloyl groups in a single molecule, and, has a surface tension of 20-25 mN/m at 25° C. The hard coat layer (D) has a refraction index differing from that of the triacetylcellulose film (A) by 0.1 or less, a surface water contact angle being 80 degrees or more, and at most two spot defects which are larger than 70 μm in 1-square-meter of the sheet.

### CROSS REFERENCE TO RELATED APPLICATION

This application claims priority to Japanese application number 2007-080436, filed on Mar. 27, 2007, which is incorporated herein by reference.

### BACKGROUND OF THE INVENTION

1. Field of the Invention

This invention relates to a hard coat film.

2. Description of the Related Art

Until now, the surface toughness of optical function films, typically plastic films which are applied to various display devices such as LCDs (liquid crystal displays), etc. have been obtained by coating, for instance, UV (ultraviolet ray)-curable acrylic resins. Such optical films are required to have a high quality free from spot defects or dot defects caused by dusts, impurities, repellency (or solvent-shedding quality of the surface), etc., especially applied to monitor displays for computers often peered over closely by users. And as large sized TVs penetrate the market recently, large sized films without spot defects are in demand. As for optical films for small displays on cell phones and so on, an antifouling property, for example, which makes it easy to wipe away fingerprints, is required as well as surface toughness since it is repeatedly touched by fingers.

As a method for reducing spot defects, an idea has been proposed to produce a sheet of tape-shaped optical compensation film in which the solution is made by dissolving discotic liquid-crystal compound in an organic solvent which should be filtered prior to being coated on the film (see the following Patent Document 1). By the technique described in the Patent Document 1, however, productivity tends to fall due to the additional process step of filtration. And furthermore, it still remains particularly difficult to sufficiently decrease defects caused by repellency. Thus, optical films containing surface-active components such as certain kinds of silicone and/or organofluorine compounds have been proposed (see the following Patent Document 2, for example). The approach proposed in Patent Document 2 makes it possible to reduce the defects caused by repellency and control how much the film surface sheds solvent (surface wettability), repels dirt (antifouling property), dust (dust resistance), and electric charge (antistatic property)

As a method for improving the antifouling property, a film which has an antifouling layer on the hard coat layer has been proposed. (See the following Patent Documents 3 and 4, for example). In addition, there is another document that reports a technique for making a hard coat layer with antifouling property (see the following Patent Document 5). According to this technique, materials which form an antifouling layer and/or a lubricating layer which is easy to segregate and/or precipitate in the interfacial air, are preliminarily mixed in the raw composition of a hard coat and then hardened on the substrate by a cationic curing method without using a solvent. Furthermore, a lubricating surface of a hard coat layer is also an alternative to improve antifouling property.

In order to increase the surface toughness, in general, the thicker the hard coat layer, the better the film is. There is an inconvenience, however, in that a hard coat layer and/or substrate film tends to buckle up and be distorted because much of the composition of a hard coat layer is a polymer material which shrinks when a thick coat of it is applied and hardened. Therefore several attempts have been made which aim to improve adhesion between the hard coat layer and a substrate film so as to prevent them from becoming distorted. For example, a hard coat film with a primer layer between a transparent substrate and a hard coat layer is proposed (see the following Patent Documents 6, for example).

### Patent Document 1: JP-A-2000-304926

### Patent Document 2: JP-A-2006-154709

### Patent Document 3: JP-A-2003-94588

### Patent Document 4: JP-A-2003-260761

### Patent Document 5: JP-A-2005-194485

### Patent Document 6: JP-A-2002-338720

### SUMMARY OF THE INVENTION

The manufacturing process of an optical film described in Patent Document 2, however, requires a filtration step which leads to a decrease in productivity. And films described in Patent Documents 3 and 4 also have the problem of increasing costs and/or decreasing productivities. In the technique described in Patent Document 5, the lack of use of any solvent brings about non-flatness of the composition of a hard coat, inducing many mura (non-uniformity) defects and/or spot defects caused by repellency. Furthermore, when a primer layer is arranged as in the case of Patent Document 6, problems arose such as interference fringes arising from a difference in a refraction index between the hard coat layer and the substrate film, an enriched haze and an increase in production costs.

The present invention was invented while considering the above mentioned factors and the purpose of the invention is to provide a hard coat film with few spot defects and few fringe patterns, as well as good antifouling property, strong adhesiveness, highly lubricating and a tough surface.

### BRIEF DESCRIPTION OF THE DRAWINGS

FIG. 1 is a cross sectional view showing one embodiment of the hard coat film of the present invention.

### DESCRIPTION OF REFERENCE NUMERALS AND SIGNS

10: hard coat film
11: substrate film (triacetylcellulose film) (A)
12: hard coat layer (D)
13: function layer

### DESCRIPTION OF THE PREFERRED EMBODIMENTS

As a result of investigations, the inventor discovered that the surface tension of a hard coat liquid, which was later transformed into the hard coat layer, affected the number of spot defects, antifouling property, lubrication characteristic and hardness of the surface. In addition, the inventor also found that using a hard coat liquid made from a reactive polyether modified silicone compound enabled the surface tension to be controlled. And the invention was finally completed after the inventor developed a technique that make the adhesion between the hard coat layer and the substrate film strong avoiding generation of fringe patterns by means of using of solvent in which the substrate film was swollen or dissolved.

The present invention will be described in detail below.

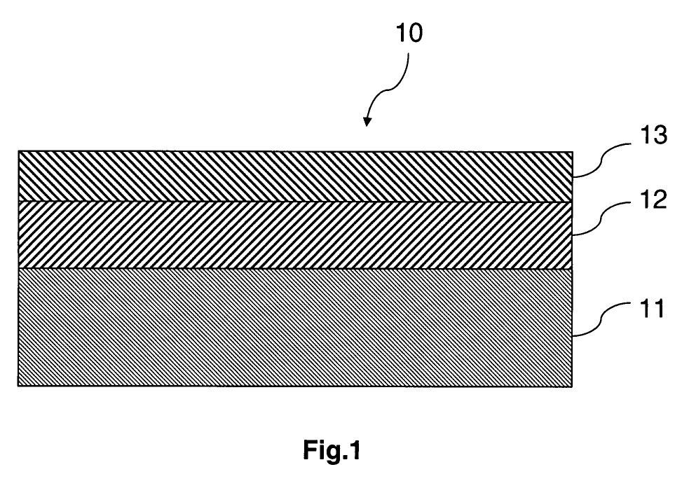

FIG. 1 shows a cross-sectional diagram of a hard coat film of one embodiment of this invention. In the hard coat film (10) of this invention, the hard coat layer (D) (12) is formed laminated on at least one side of a triacetylcellulose film (A) (11) which acts as a substrate film.

The triacetylcellulose film (A) (11) (this is also referred to as “(A) film” in this document) has low birefringence and is excellent in terms of optical specifications such as transparency, refraction, dispersion, and various properties such as impact resistance, heat resistance and endurance. Moreover, the triacetylcellulose film (A) (11) can be swollen and/or dissolved by a commercially available solvent. It is possible to use commercial products, for example “TDY80” manufactured by FUJIFILM as the (A) film (11). The (A) film (11) may contain a variety of additive agents such as stabilizer, ultraviolet absorber, plasticizer, lubricant, colorant, antioxidant, fire retardant, etc.

Although there are no restrictions on the thickness of the (A) film (11), preferably it is in the 20 μm to 200 μm range, or to be more precise in the 40 μm to 80 μm range. If the thickness is under 20 μm, the film lacks sufficient strength for a substrate film. On the other hand, a thickness more than 200 μm would make it difficult to handle as a substrate film.

Hard coat layer (D) (12) is obtained by caking the hard coat liquid. The hard coat liquid contains a UV-curable resin ingredient and a solvent (E) in which the (A) film dissolves or swells. The main components of the UV-curable resin ingredient are a polyfunctionalized monomer (B) which has more than two (meth)acryloyl functionalities in a single molecule (this is also hereinafter called “(B) component”) and a reactive polyether modified silicone compound (C) (this is also hereinafter called “(C) component” in this document). The content of the UV-curable resin ingredient in 100 mass % of the hard coat liquid is preferably in the 20-80 mass % range, or to be more accurate in the 40-60 mass % range. If the content is less than 20 mass %, the toughness of the surface becomes insufficient. If the content is more than 80 mass %, flatness of the hard coat film becomes worse. The meaning of “Flatness of the hard coat film is good” in this document is that there is a high degree of in-plain thickness uniformity in a hard coat layer (D) formed on a substrate. On the contrary, “Flatness of the hard coat film is bad” refers to a fact that the hard coat layer (D) does not have uniform in-plain thickness and looks uneven in this document.

(B) component is based on a polyfunctionalized monomer with more than two (meth)acryloyl functional groups per molecule. Examples for polyfunctionalized monomers are as follows: 1,4-butanediol di(meth)acrylate, 1,6-hexanediols di(meth)acrylate, neopentylglycol (meth)acrylate, ethyleneglycol di(meth)acrylate, triethyleneglycol di(meth)acrylate, tripropyleneglycol di(meth)acrylate, dipropyleneglycol di(meth)acrylate, 3-methylpentanediol di(meth)acrylate, diethyleneglycol bisβ-(meth)acryloyloxypropynate, trimethylolethane tri(meth)acrylate, trimethylolpropane tri(meth)acrylate, pentaerythritol tri(meth)acrylate, dipentaerythritol hexa(meth)acrylate, tri(2-hydroxyethyl)isocyanate di(meth)acrylate, pentaerythritol tetra(meth)acrylate, 1,7,7-trimethyl-2,3-bis(meth)acryloyloxybicyclo[2.2.1]heptane, poly(1,2-butadiene)(meth)acrylate, 1,2-bis(meth)acryloyloxymethylhexane, nonaethyleneglycol di(meth)acrylate, tetradecaethyleneglycol di(meth)acrylate, 10-tetradecanediol di(meth)acrylate, 3,8-bis(meth)acryloyloxymethyltricycle[5.2.1.0]decane, hydrogenize bisphenol A di(meth)acrylate, 2,2-bis(4-(meth)acryloyloxydiethoxyphenyl)propane, 1,4-bis((meth)acryloyloxymethyl)cyclohexane, hydroxypyvalypivlate di(meth)acrylate, di(meth)acrylate of bisphenolA diglycidyl ether, and di(meth)acrylate of bisphenol A modified epoxide.

In addition, commercial polyfunctional monomers are also available. One type of these polyfunctional monomers may be used alone or two or more types may be used together. If necessary, they may be used with a mono-function monomer together and copolymerized.

As a polyfunctionalized monomer of (B) component, urethane (meth)acrylate, which is formed chemically by reacting polyalcohol, multivalent isocyanate and acrylate which has hydroxyl group together, is available. Practically, any of the following products is available. UA-306H, UA-306T, UA-306I or the like, which are made by KYOEISHA CHEMICAL Co., LTD. UV-1700B, UV-6300B, UV-7600B, UV-7605B, UV-7640B, UV-7650B etc., which are made by Nippon Synthetic Chemical Industry Co., Ltd. U-4HA, U-6HA, UA-100H, U-6LPA, U-15HA, UA-32P, U-324A etc., which are made by SHIN-NAKAMURA CHEMICAL Co., LTD. Ebecryl-1290, Ebecryl-1290K, Ebecryl-5129 etc., which are made by DAICEL-CYTEC COMPANY LTD. UN-3220HA, UN-3220HB, UN-3220HC, UN-3220HS etc., which are made by NEGAMI CHEMICAL INDUSTRIAL Co., LTD.

The content of (B) component is preferably in the range 50-100% by mass, or to be more precise in the range 80-100% by mass in 100% by mass of a UV-curable resin ingredient (excluding (C) component). If the content of (B) component is less than 50% by mass, it becomes difficult to obtain the hard coat layer (D) having sufficient strength.

(C) components are polydimethylsiloxane compounds which have reactive substituents such as a polyether modified acryloyl group. The reactive substituent(s) in (C) component preferably have at least one kind of the following substituent groups: Methacryloyl group, acryloyloxy group and vinyl group. Acryloyl group is in particular the most preferable among them. The substitution sites of these reactive groups may be either in a side chain, at one of the terminals of the main chain, at both of the terminals of the main chain, or at a terminal of a side chain, in relation to the silicone main chain.

There are some products acting as (C) component available in the market. For example “BYK-UV3500”, “BYK-UV3570” and etc. made by BYK-Chemie Japan KK can be cited.

Because the (C) component is a polydimethylsiloxane compound having a substituted reactive functional group, the caked hard coat layer (D) hardly bleeds and therefore it is possible to form the hard coat layer (D) which keeps strong antifouling property and surface lubrication. Consequently, the hard coat layer (D) acquires high rub resistance. And also, because the (C) component comprises a polyether modified group, the surface tension of the hard coat liquid can be adjusted lower so as to improve its fluidity sufficiently to reduce dot defects caused by repellency of the surface of the hard coat layer (D). In addition, it is possible to make adhesiveness between the hard coat layer (D) and (A) film stronger than before by means of making a water contact angle of the hard coat layer (D) so large that a piece of cellophane tape attached to the surface of it can be easily stripped off.

The content of (C) component is preferably in the 0.01-0.3 range by mass, or to be more precise 0.03-0.1 by mass relative to the (B) component quantity of 100 by mass. If the content of (C) component is less than 0.01 by mass, spot defects caused by repellency etc. tend to be generated more easily and antifouling property tends to be depressed. On the other hand, if the content of (C) component exceeds 0.3 by mass, manufacturing errors such as misalignments and so on tend to occur frequently in the process of rewinding the hard coat film in rolls.

The UV-curable resin ingredient in the present invention may be comprised of only the (B) component and (C) component, although it may contain other components, too. For examples of these “other components”, there are cross-linked polymers such as melamine resins, epoxy resins, acrylic resins and urethane resins, etc.

Solvent (E) is an organic solvent in which the (A) film dissolves or swells. Such an organic solvent serves to improve adhesion of the hard coat layer (D) to the (A) film. Examples of solvent (E) include ethers such as dibutyl ether, dimethoxymethane, dimethoxyethane, diethoxyethane, propylene oxide, 1,4-dioxan, 1,3-dioxolane, 1,3,5-trioxane, tetrahydrofuran, anisole, phenetole; ketones such as acetone, methyl ethyl ketone, methyl isobutyl ketone, methyl butyl ketone, diethyl ketone, dipropyl ketone, diisobutyl ketone, cyclopentanone, cyclohexanone, and methylcyclohexanone; Esters such as ethyl formate, propyl formate, n-pentyl formate, methyl acetate, ethyl acetate, methyl propionate, ethyl propionate, n-pentyl acetate and γ-butyrolactone; cellosolve such as methyl cellosolve, Cellosolve, butylcellosolve and cellosolve acetate. Particularly, dibutyl ether, dimethoxyethane, methyl acetate, ethyl acetate, methyl ethyl ketone, acetylacetone and cyclohexanone are preferable, and methyl acetate, methyl ethyl ketone are the most preferable among them. Two kinds of these solvents may be used together or one kind alone. Especially, methyl ethyl ketone alone or a combined solvent of methyl acetate and methyl ethyl ketone is preferable. When the solvent (E) is a combined solvent of methyl acetate and methyl ethyl ketone, the preferable ratio by mass is 25-75% of methyl acetate and 75-25% of methyl ethyl ketone.

On the other hand, for example, hydrocarbons such as toluene, xylene, cyclohexane, and n-hexane, and alcohols such as methanol, ethanol and 2-propanol are solvents or liquids in which the (A) film does not dissolve or swell. Here, it is noted that a solvent in which more than half of the initial volume of the (A) film is dissolved should be regarded as “a solvent in which the (A) film does dissolve” in this document. Similarly, it is noted that a solvent or liquid which is imbibed by the (A) film when the (A) film is immersed in a solvent and thus increases the volume of the (A) film should be regarded as “a solvent or a liquid in which the (A) film does swell” in this document.

The content of the solvent (E) is preferably 20-80% by mass out of 100% by mass of the entire hard coat liquid (solution). To be more precise, 40-60% by mass is more preferable. If the content of the solvent (E) is less than 20% by mass, flatness of the hard coat layer (D) tends to be worse. If the content of the solvent (E) is more than 80% by mass, it tends to be difficult to obtain a sufficient surface toughness of the hard coat layer (D). The content of the solvent (E) is preferably 20-100 by mass relative to 100 by mass of (B) component. To be more precise, it is preferably 40-100 by mass.

The hard coat liquid of this invention may contain a photoinitiator and/or photosensitizer along with a UV-curable resin ingredient and solvent (E) described above. It may also contain a modifier to improve the characteristics of the hard coat layer (D). Examples of a photoinitiator are 2,2-diethoxyacetophenone, 1-hydroxycyclohexyl phenyl ketone, dibenzoyl, benzoin, benzoin methylic ether, benzoin ethyl ether, p-chlorobenzophenone, p-methoxy benzophenone, 4,4′-bis(dimethylamino)benzophenone), acetophenone, 2-chlorothioxanthone. One kind of photoinitiators above can be used or more than two kinds together. The content of the photoinitiators is preferably in the 0.5-5% range by mass relative to 100% by mass of the entire hard coat liquid. To be more precise, 1-3% by mass is more preferable. If the content is less than 0.5% by mass, a hardening reaction under light irradiation does not take place sufficiently. If the content is more than 5% by mass, a polymerization reaction sometimes ends before light irradiation can encourage the reaction at the lower part of the hard coat layer.

Examples of a photosensitizer aretertiary amines such as triethylamine, triethanolamine and 2-dimethyl aminoethanol, alkyl phosphine reagents such as triphenylphosphine, and thioether reagents such as β-thiodiglycol. One kind of these photosensitizers can be used alone or more than two kinds together. The content of these photosensitizers is preferably 0.1-3% by mass compared to 100% by mass of the entire hard coat liquid. Examples of a modifier are antifoamer, planarizing agent, redox agent, UV absorber, light stabilizer, and antipolymerizing agent. The content of the modifier is preferably 0.1-3% by mass within 100% by mass of the entire hard coat liquid.

A hard coat liquid containing each component mentioned above has a surface tension of 20-25 mN/m. A surface tension of less than 20 mN/m serves to repel solvent or liquid on (A) film and to increase spot defects. A surface tension of more than 25 mN/m makes the hard coat layer (D) less antifouling and low slipping and thus it becomes more difficult to wipe off greasy fingerprints and the like. Consequently, the rub resistance of the hard coat layer (D) tends to decrease. From this point of view, the preferable surface tension is from 22 to 24 mN/m.

Such a hard coat liquid is hardened on at least one side of the (A) film and is caked to form a hard coat layer (D). The thickness of the hard coat layer (D) is determined by the required toughness, however, it should be less than 20 μm and preferably in the 3 μm to 12 μm range. The thicker the hard coat layer, the less accurate the coating process is and the more likely the hard coat layer will deform or bend. Then, it will be difficult to handle the resulting hard coat film.

The manufacturing process of the hard coat film of the present invention will be explained below. The hard coat liquid is coated on at least one side of the (A) film. Any heretofore known technique of coating, for instance wet coating method (including dip coating method, spin coating method, flow coating method, spraying coating method, roll coating method, gravure roll coating method, air doctor coating method, blade coating method, wire doctor coating method, knife coating method, reverse coating method, transfer roll coating method, microgravure coating method, kiss coating method, cast coating method, slot orifice coating method, calender coating method, die coating methods etc.), may be applied to this invention.

The hard coat liquid coated on the film (A) is subsequently dried (its solvent is evaporated). For this step, a drying method heretofore known can be applied.

Next, a dried hard coat liquid is for example irradiated with UV light to form a hard coat layer (D) in order to make a hard coat film. For UV irradiation, high-pressure mercury vapor lamp, halogen lamp, xenon lamp, and the like as well as electrodeless lamps including a fusion lamp etc. are available. The UV irradiance level is preferably in the range 100-800 mJ/cm2 in general. Instead of a UV irradiation process as described above, a heating process of the dried hard coat liquid may also be applied to form a hard coat layer (D).

The hard coat film gained in this way is supposed to have a difference of not more than 0.1 in refractive index between the (A) film and the hard coat layer (D). A difference of more than 0.1 in refractive index between them tends to cause interference fringes to arise. Thus, a difference in index of refraction of not more than 0.05 is more preferable. In addition, the water contact angle of the hard coat layer (D) surface has to be equal to or exceed 80 degrees. A water contact angle less than 80 degrees reduces the lubricating of the hard coat layer (D) so that it becomes difficult to wipe off greasy fingerprints and the like. Therefore, the water contact angle is preferably more than 90 degree. Furthermore, the number of spot defects which are not less than 70 μm should not exceed two or more within one square meter of the hard coat film. “Contact angle” means the angle between a solid surface and tangency to a liquid (water etc.) surface at the point where a solid and a liquid meet and indicates the angle in the direction which includes the liquid in this invention.

A hard coat film of the present invention can be pasted on a display surface, for example LCD, PDP (plasma display panel), CRT display and so on, making a display with excellent rub resistance.

As described above, the hard coat film of the present invention involves a hard coat layer (D) made from a hard coat liquid comprising a UV-curable resin ingredient, which consists mainly of a polyfunctional monomer (B) and a reactive polyether modified silicone compound (C), and a solvent (E), in which the triacetylcellulose film (A) dissolves or swells. Consequently, the surface tension of the hard coat liquid becomes 20-25 mN/m, the difference in refractive index between the hard coat layer (D) and the triacetylcellulose film (A) becomes not more than 0.1, and a water contact angle of the hard coat layer (D) becomes not less than 80 degrees. As a result, a hard coat film with few interference fringes, a tough surface, strong adhesiveness, highly slipping and antifouling property can be obtained. In addition, because the average number of spot defects which are larger than 70 μm decreases to not more than two per one square meter of the hard coat layer (D), it is possible to obtain a hard coat film with few spot defects as well.

In the present invention, after forming the hard coat film (D), functional layer(s) (13) may be formed on the hard coat layer (D) (12) as shown in FIG. 1, if required. The functional layer(s) (13) may have for example, AR (antireflective) property, antistatic property, antifouling property, AG (anti-glare) property, electromagnetic interference shielding property, IR (infrared) absorption property, UV absorption property and/or color correction property. Specifically, the functional layers (13) can be AR layer, antistatic layer, antifouling layer, AG layer, electromagnetic shield layer, IR absorbing layer, UV absorbing layer, color correction layer and the like.

These functional layers may consist either of a single layer or a plurality of layers. An AR layer, for example, may consist either of a single layer with low refraction or of a plurality of repeated layers of alternating low and high refractions. The functional layer (13) may also have multiple functions in a single layer such as an antifouling AR layer.

As stated above, there are a number of options for the structure of an AR layer on the hard coat layer, such as an AR layer having a set of stacked layers repeating low and high refraction alternately, or an AR layer having a single layer of a low refraction layer. As a method for forming these AR layers, either of the following technology, vacuum process technology such as vacuum vapor deposition method, spattering method or CVD (chemical vapor deposition) method, or wet process technology such as coating an AR forming liquid on the surface, may be applied.

For example, a low refraction single layer corresponding to an AR layer is formed by means of a wet process technique coating a forming liquid of a low refraction layer onto the surface of the hard coat layer. The film thickness (d) of the low refraction single layer corresponding to the AR layer here is designed so that the optical thickness (nd) should be equal to ¼ of the wave length of visible light, while the optical thickness (nd) is given as a result of multiplication of (d) by (n), where (n) is a refraction factor of the low refraction layer. Low refraction particles, a binder matrix forming material and, if necessary, a solvent are available as the forming liquid for the low refraction layer. The low refraction layer whose low refraction particles are dispersed in a binder matrix is formed by means of a wet process.

The low refraction particles here are made of, for example, low refraction material such as magnesium fluoride and/or potassium fluoride etc. In addition, particles with a space within the particle are also available as low refraction particles. As a binder matrix forming material, a UV-curable resin ingredient and/or a metal alkoxide such as silicon alkoxide are available.

In addition, an AR layer is obtained by forming a low refraction layer and a high refraction layer by vacuum process technology, respectively. One such example is a double layer structure of (starting from the hard coat layer side) high refraction layer and low refraction layer. Another example of an AR layer repeating low and high refraction alternately is a four-layer structure of (starting from the hard coat layer side) high refraction layer, low refraction layer, high refraction layer, and low refraction layer.

As a high refraction layer forming material, a metal such as indium, tin, titanium, zinc, zirconium, niobium, etc., or an alloy made from more than two kinds of these metals, an oxide, a fluoride, a sulfide, a nitride, or the like, of those metals, specifically, metal oxide such as titanium oxide, niobium oxide, zirconium oxide, tantalum oxide, zinc oxide, indium oxide, cerium oxide, indium tin oxide, etc. can be used. In addition, in the case where plural high refraction layers are stacked, it is not necessary to use the same material for each layer. Any appropriate materials for each purpose can be chosen and applied.

As a low refraction layer material, silicon oxide, titanium nitride, magnesium fluoride, barium fluoride, calcium fluoride, hafnium fluoride, lanthanum fluoride and so on, can be used but not limited to these. Furthermore, even in the case where plural low refraction layers are stacked, it is not necessary to choose the same material for each layer. Any appropriate materials for each purpose can be chosen and applied. Silicon oxide, which is a kind of metal oxide, is an especially preferable material in aspects of its optical characteristics, strength, cost, film properties, etc.

It is possible to form an AR layer by sequentially depositing these high and low refraction layer materials by means of vacuum process technology. As a vacuum process technology, for example, vacuum vapor deposition method, resistance heating method, ion plating method, ion beam for vacuum film formation method, sputtering method, CVD method, are available.

A middle refraction layer can also be arranged between high and low refraction layers in the AR layer.

With regard to the production of an antistatic layer corresponding to the functional layer, metal oxides such as zinc oxide, indium oxide, indium tin oxide and the like can be deposited by means of vacuum process technology. A forming liquid of an antistatic layer, which contains particles of conductive metal oxide such as zinc oxide, indium oxide, indium tin oxide etc. and a binder matrix forming material are coated on the coating layer and, if necessary, expose to ionization radiation and/or heated. Then, an antistatic layer in which the conductive metal oxide particles are dispersed within the binder matrix is formed.

Furthermore, before a functional layer is formed on the hard coat layer, surface treatments such as acid treatment, alkali treatment, corona approach, atmospheric pressure glow discharge plasma method etc. may be performed before forming the functional layer. It is possible to improve adhesiveness between the hard coat layer and functional layer by performing these surface treatments.

A hard coat film of the present invention can be arranged on the surface of a display device, for example, LCD. At that time, the hard coat film can be used as one part of a polarization plate of an LCD device. This polarization plate is produced by laminating a polarization layer on the other surface of the triacetylsellulose film on which a hard coat later of the present invention is not formed, followed by arranging another fresh triacetylsellulose film stacked thereon. An extended PVA (polyvinyl alcohol) can be used as a polarization layer.

In another word, the hard coat film of the present invention can form a polarization plate by sandwiching a polarization layer which is the hard coat film and another triacetylsellulose film. Moreover, a pair of the polarization plates containing a hard coat film of the present invention placed facing each other across a liquid crystal cell and assembled with a backlight, diffusion film, optical prism sheet, etc. can be used as an LCD. In this assembling, the hard coat films of the present invention are arranged so that the hard coat layers should become the outermost layers. The hard coat films of the present invention are utilized as a means to decrease spot defects and interference fringes, and have antifouling property, strong adhesiveness, highly slipping characteristics and surface hardness and can be suitably applied to the surface of display devices.

According to the present invention, it is possible to realize a hard coat film with reduced spot defects and interference fringes, excellent antifouling property, strong adhesiveness, high slipping characteristics and a high level of surface toughness.

### PRACTICAL EXAMPLES OF THE PRESENT INVENTION

Though some embodiments of the present invention will be described below, it is not limited to them.

### <Reagents—for Forming Hard Coat Layer>

Common reagents used in the following practical examples of the present invention and their comparative examples are as follows.
Polyfunctional monomer (B): “PE-3A” (made by KYOEISHA CHEMICAL Co., LTD.) Reactive polyether-modified silicone composition (C): “BYK-UV3500” (made by BYK-Chemie Japan KK)
Reactive polyether-modified silicone composition (C): “BYK-UV3570” (made by BYK-Chemie Japan KK)
Photoinitiator (E): “Irgacure184” (made by Ciba Specialty Chemicals KK)
Others: Acrylic copolymer “BYK-350” (made by BYK-Chemie Japan KK)

### <Measurements and Evaluations>

The characteristics and performances of hard coat films were measured and evaluated according to the following methods,

### <Liquid (Coat Solution) Characteristics>

### (1) Surface Tension

The surface tension of the hard coat liquid was measured with surface tensiometer “CBVP-Z type” (made by Kyowa Interface Science Co., LTD.) at 25° C.

### <Appearance>

### (2) Spot Defects

After a cut of 1 square meter size, the sample of the hard coat film was placed on a black plate. A reflection was examined using fluorescent light and defects were visually checked. Then, these defects were observed with an optical microscope and the number of defects caused by repellency but involving no core impurity was counted.

### (3) Difference in Refraction Index

Refractive indexes of a substrate film and a hard coat layer were measured with an Abbe refractometer “NAR-1T” (made by ATAGO Co., LTD.), respectively. Then, the difference between them was calculated.

### (4) Interference Fringes

Samples similar to those of section “(2) Spot defects” were observed by an optical microscope and checked for interference fringes.

### <Antifouling Property>

### (5) Water Contact Angle

The inventors made spherical droplets of 2 mm in diameter on a needlepoint by a contact angle meter (Kyowa Interface Science Co., LTD. “CA-X”) under a dry state condition (20□, 65% RH). Then the droplet was brought into contact with the hard coat layer surface of the hard coat film and measured the contact angle of a direction which includes this droplet. Distilled water was used for the droplet.

### (6) Wiping Off Oil-Based Ink

Oil-based ink was attached to the surface of the hard coat layer of the hard coat film by a pen and was wiped off with disposable cellulose-based nonwovens “BEMCOT M-3” (made by Asahi Kasei Corp.). Ease of wiping was judged by a visual evaluation. The evaluation criteria are as follows;

∘: The ink is completely wiped off.

□: Traces of the ink are left behind

x: The ink could not be wiped off

### (7) Wiping Off Fingerprints

Fingerprints were attached to the surface of the hard coat layer of the hard coat film and were wiped off with disposable cellulose-based nonwovens “BEMCOT M-3” (made by Asahi Kasei Corp.). Ease of wiping was judged by a visual observation. The evaluation criteria are as follows;

∘: The fingerprints were completely wiped off.

□: Traces of the fingerprints were left behind

x: The fingerprints could not be wiped off

### <Mechanical Property>

### (8) Adhesiveness

Adhesiveness was evaluated based on a cross-cut-tape peel test.
100 1-mm-square pieces of the surface of the hard coat layer of the hard coat film were cut. Then, a piece of cellophane tape (“Cellotape (a registered trademark)” made by NICHIBAN CO., LTD. 24 mm in width for industry use) was attached to all of the 100 pieces and it was peeled away.
Here, it is judged whether each of the hard coat layers was detached from the film substrate, and the number of 1 square-meter pieces of hard coat layer left on the substrate film out of initial 100 pieces was counted.

### (9) Rub Resistance

Rub resistance was evaluated by a steel-wool test.
The surface of the hard coat layer of the hard coat film was rubbed against by reciprocating movement of steel-wool (“BON STAR #0000” made by Nihon Steel Wool Co., Ltd.) with a pressure of 250 g/cm², 500 g/cm² or 1000 g/cm², and judged whether there were any scratches by visual observation. The evaluation criteria are as follows.

∘: No scratch damage was found. •: Some scratches were found. x: Many scratches were found.

### Practical Example 1

The mixture whose blend ratio was shown in FIG. 1 was stirred and a hard coat liquid was prepared. Then, the hard coat liquid was coated on a roll of triacetylcellulose film (“TDY80” 80 μm thickness, made by FUJIFILM Corp.) as the substrate film, which was being wound off and carried at the rate of 30 m/minute so that the hard coat layer became about 4.5 μm thick by means of micro gravure coating technology. After drying at 50° C. for 30 seconds, the film was irradiated with UV light of an illumination intensity of 400 mW/cm² and an irradiance level of 280 mJ/cm², by means of an electrodeless H valve lamp (made by Fusion UV Systems Japan KK). In this way, the hard coat layer was formed on the substrate film, and the resulting “hard coat film” was taken up in a roll. Table 1 shows the prepared hard coat liquids along with their measurement results and the evaluations of the resulting hard coat films.

### Practical Example 2

### Comparative Examples 1 to 4

Except for the substitutions and the blending quality of the composition of hard coat liquid to those shown in Table 1, preparations, measurements and evaluations similar to those in “practical example 1” were performed. The results are also shown in Table 1. It should be noted that acrylcopolyer was used in place of a reactive polyether modified silicone compound in comparative example 2, and toluene was used in place of solvent (E) in comparative example 4.

TABLE 1

| | | | | | Comp. | Comp. | Comp. | Comp. |
|---|---|---|---|---|---|---|---|---|
| Component | | | Ex. 1 | Ex. 2 | Ex. 1 | Ex. 2 | Ex. 3 | Ex. 4 |
| Polyfunctional | | PE-3A | 100 | 100 | 100 | 100 | 100 | 100 |
| monomer (B) | | | | | | | | |
| Silicone | | BYK-UV | 0.05 | | | | 0.005 | |
| compound (C) | | 3500 | | | | | | |
| | | BYK-UV | | 0.1 | | | | 0.1 |
| | | 3570 | | | | | | |
| Acryl | | BYK-UV | | | | 0.1 | | |
| copolymer | | 350 | | | | | | |
| Photopolymerizetion | | Irugacure- | 5 | 5 | 5 | 5 | 5 | 5 |
| initiator | | 184 | | | | | | |
| Solvent (E) | | MeEt- | 100 | 70 | 100 | 100 | 100 | |
| | | ketone | | | | | | |
| | | AcMe | | 30 | | | | |
| Solvent | | toluene | | | | | | 100 |
| Evaluation | Coating | Surface | 23.6 | 22.4 | 29.3 | 28.5 | 25.4 | 24.2 |
| | liquid | tension of hard | | | | | | |
| | property | coat liquid | | | | | | |
| | | (mN/m) | | | | | | |
| | Appearance | Spot defect: | 0 | 0 | 15 | 1 | 3 | 0 |
| | | (Repellency) | | | | | | |
| | | (num.) | | | | | | |
| | | Difference in | 0.03 | 0.03 | 0.03 | 0.03 | 0.03 | 0.03 |
| | | refraction | | | | | | |
| | | Interference | not | not | not | not | not | visible |
| | | fringe | visible | visible | visible | visible | visible | |
| | Antifouling | Water contact | 89.5 | 95.7 | 64.5 | 68.7 | 78.6 | 95.3 |
| | property | angle (°) | | | | | | |
| | | Oil-based ink | ◯ | ◯ | X | X | Δ | ◯ |
| | | wiping | | | | | | |
| | | Fingerprint | ◯ | ◯ | X | X | Δ | ◯ |
| | | wiping | | | | | | |
| | Mechanical | Adhesiveness | 100/100 | 100/100 | 100/100 | 100/100 | 100/100 | 0/100 |
| | property | (num./100) | | | | | | |

| | | | | | | | |
|---|---|---|---|---|---|---|---|
| Rub | 250 | ◯ | ◯ | ◯ | ◯ | ◯ | ◯ |
| res. | (g/cm2) | | | | | | |
| | 500 | ◯ | ◯ | Δ | Δ | ◯ | ◯ |
| | (g/cm2) | | | | | | |
| | 1000 | ◯ | ◯ | Δ | Δ | Δ | ◯ |
| | (g/cm2) | | | | | | |

It is clear from Table 1 that the hard coat film in practical example 1 and 2, whose hard coat liquid surface tension was 20-25 mN/m, difference in refraction indexes between hard coat layer and substrate film were less than 0.1, water contact angles of the hard coat layer were more than 80 degrees, had no spot defects which were larger than 70 μm-size in an area corresponding to 1-m²-hard coat film sheet. In addition, no interference fringe was found, oil-based ink and fingerprints were wiped away easily, and their surfaces were highly slipping and antifouling. Moreover, they realized strong adhesiveness as well as rub resistance and surface hardness. Alternatively, comparative example 1 and 2, whose hard coat liquid surface tension exceeded 25 mN/m and water contact angles of the hard coat layer were less than 80 degrees since their hard coat liquid contained no reactive polyether modified silicone compound (C), produces spot defects which was larger than 70 μm-size. Especially, no less than 15 defects were found in comparative example 1. In addition, their surfaces were less slipping and antifouling in comparative examples 1 and 2 than those in examples 1 and 2 of the present invention. As the hard coat liquid of comparative example 3 contained reactive polyether modified silicone compound (C), a little improvement occurred with respect to lubricating, antifouling properties and the number of spot defects. Nevertheless, the hard coat film of comparative example 3 still remains inferior to those of examples 1 and 2 of the present invention because the compound (C) is not sufficiently added. In comparative example 4, where toluene, in which triacetylcellulose films (substrate films) did not dissolve or swell, was used instead of solvent (E), interference fringes were found on the surface of the hard coat layer. Its adhesiveness was also inferior to those of practical examples 1 and 2 of the present invention.

What is claimed is:

1. A hard coat film comprising:
a triacetylcellulose film; and
a hard coat layer formed on at least one side of said triacetylcellulose film, said hard coat layer being a sheet of caked hard coat liquid, said hard coat liquid having a surface tension of 20-25 mN/m at 25° C. and including a UV-curable resin ingredient having primarily a reactive polyether modified silicone compound and a polyfunctional monomer, said polyfunctional monomer having at least two metaacryloyl groups in a single molecule, said hard coat liquid also containing a solvent in which said triacetylcellulose film dissolves or swells, said hard coat layer having a refraction index differing from that of said triacetylcellulose film by 0.1 or less, and a surface water contact angle being 80 degrees or more, said hard coat layer having at most two spot defects which are larger than 70 μm per 1-square-meter of said hard coat sheet.

2. The hard coat film according to claim 1, wherein said reactive polyether modified silicone compound has an acryloyl group in its single molecule and its amount ratio is 0.01-0.3 parts by mass to 100 parts by mass of said polyfunctional monomer.

3. The hard coat film according to claim 1, wherein said solvent comprises at least one of dibutyl ether, dimethoxyethane, methyl acetate, ethyl acetate, methyl ethyl ketone, acetylacetone, or cyclohexanone.

4. The hard coat film according to claim 1, wherein said solvent comprises 25-75% by mass of methyl acetate and 75-25% by mass of methyl ethyl ketone.
